(19) United States
(12) Patent Application Publication
(10) Pub. No.: US 2004/0221304 A1
(43) Pub. Date: Nov. 4, 2004

(54) Digital video recording and playback system with seamless advertisement insertion and playback from multiple locations via a home area network

(76) Inventors: Carlton J. Sparrell, Marblehead, MA (US); Peter A. Kaczowka, Townsend, MA (US); Alex Vasilevsky, Westford, MA (US)

Correspondence Address: COVINGTON & BURLING, ATTN: PATENT DOCKETING, 1201 PENNSYLVANIA AVENUE, N.W., WASHINGTON, DC, 20004-2401, US

(21) Appl. No.: 10/777,217

(22) Filed: Feb. 13, 2004

Related U.S. Application Data
(60) Provisional application No. 60/447,261, filed on Feb. 13, 2003.

(51) Int. Cl. H04N 5/445; G06F 3/00; H04N 7/10; H04N 7/025; G06F 13/00

(52) U.S. Cl. 725/34; 725/35; 725/42; 725/41

(57) ABSTRACT

Embodiments of the invention may be used to select targeted advertisements for insertion into a program being rendered on a rendering device in a home area network. The selection of the advertisement may be based on a profile associated with that particular rendering device. In other embodiments, the profile associated with a rendering device in a home area network is updated based on an identification that the rendering device is active and based on the program being rendered on the active rendering device.

### RELATED APPLICATIONS

The present application claims the benefit under 35 U.S.C. § 120 of U.S. patent applications Ser. No. 09/809,770 filed Mar. 16, 2001, entitled “Home Area Network Including Arrangement for Distributing Television Programming Over Local Cable” (Atty. Dkt. UCN-006); Ser. No. 10/017,675 filed Dec. 15, 2001, entitled “Centralized Digital Video Recording and Playback System Accessible To Multiple Reproduction And Control Units Via A Home Area Network” (Atty. Dkt. UCN-018); Ser. No. 10/032,218 filed Dec. 21, 2001, entitled “Digital Video Recording and Reproduction System And Method Suitable For Live-Pause Playback Utilizing Intelligent Buffer Memory Allocation” (Atty. Dkt. UCN-015); Ser. No. 10/345,870 filed Jan. 16, 2003, entitled “Local Area Networked System Having Intelligent Traffic Control And Efficient Bandwidth Management a Networked Personal Video Recorder” (Atty. Dkt. UCN-024). The entirety of each of these patent applications is herein incorporated by reference.

The present application additionally claims the benefit under 35 U.S.C. § 119(e) of Unites States provisional patent application No. 60/447,261 filed Feb. 13, 2003, entitled “Digital Video Recording and Playback System with Seamless Advertisement Insertion and Playback from Multiple Locations via a Home Area Network” (Atty. Dkt. UCN-036). The entirety of this provisional patent applications is herein incorporated by reference.

### FIELD OF THE INVENTION

The present invention broadly relates to digital recording and playback systems and methods administered by home area networks. More particularly, the present invention relates to improving cooperative functionality with targeted insertion of advertisement among all of the individual receivers in the home area network without the substantial costs associated without adding substantial hardware and cost to each receiver.

### BACKGROUND OF THE INVENTION

Digital Video Recording and Playback systems are becoming more commonplace, with advances in technology and the downward trend in prices. Along with a playback quality that is superior to analog-based systems, Digital Video Recorders (DVRs) also allow other features that are not practical with analog-based systems. Among such features is the ability of a DVR user to engage in “live-pause” or “elastic” recording and playback.

Live-pause recording and playback allow a viewer/user with such an enabled system to watch a program live while the program is being simultaneously recorded, and also allows the user to use “trick play” modes or functions such as pausing the program or rewinding the program. While the recorded program is being paused or rewound, the system continues to record the program in a buffer memory. The system keeps track of where in memory the user has exited to perform trick play functions. The user can later return to the previous point of viewing in the program or skip with a “fast forward” operation up to the most current point of recording. Live-pause recording and playback allows the user the flexibility of watching a program live, already recorded, or a combination of both live and recorded viewing, along with other interesting trick play modes.

Home Area Networks (HANs) are typically small-scale electronic cable, wire or wireless based communication networks used to interconnect a variety of small to moderate sized appliances, computers, and consumer electronic devices. Their cost and attributes make them especially suitable for typical homes or smaller buildings. Communication between devices may be via one or more of several well-known protocols or information formats. HANs can be general in their functionality, such as controlling the operation of several in-home devices such as appliances, television receivers, telephonic devices and burglar alarm systems, or they may be more specialized in their functionality, such as only controlling the operation of several television receivers and connecting the receivers to an extra-home television program source such as a cable or satellite television service provider.

A well-designed and well-implemented HAN can allow resource sharing between one or more workhorse devices and the several attached devices, giving the attached devices greater capability and functionality than they would otherwise possess.

Of special interest in the present applications are home area-networked video recording and playback systems having multiple television receivers or reproduction devices. It is desirable to be able to allow the playback of the same program from different receivers. Also desirable is the ability to allow live-pause playback and delayed viewing playback from more than one receiver. Further, it is desirable to provide a mechanism for inserting advertisements in the video stream during the playback of a program (whether in a live-pause or conventional playback mode). Further, it is desirable to provide a mechanism to determine the specific advertisement inserted in the playback of a program based on the context of the playback including location of the receiver (which room of the house), time of the playback, or individual controlling the playback.

The previously known approach to facilitating the insertion of advertisements has targeted the insertion of locally relevant advertising into national broadcasts. This has been accomplished through the use of a device located at the local cable or local broadcast central office capable of detecting cues for ad-insertion and inserting advertisement segments (e.g., 30-second “spots”) into the video stream in place of existing content. One method proposed for performing this ad-insertion is detailed in the SCTE Digital Program Insertion (DPI) standard 35 2001. Other methods such as the detection of audio cues have also been employed. The limitation of this approach is that ad-insertion at the central office limits the ability of the advertiser or broadcaster to target specific demographic groups. If, for example, a broadcaster desired to sell the same ad spot to two different advertisers targeting different demographic household incomes, the broadcaster could only select the advertisement based on the demographic of the neighborhood, town or even metro-region, not on a home by home basis.

U.S. Pat. No. 6,446,261 (Rosser) describes a system capable of performing ad-insertion in the home. The system described relies on a television Set-Top Box (STB) to monitor the users input, generate a demographic profile of the user on the basis of shows watched, pre-record a library of commercial advertisements, select an advertisement to insert based on the demographic profile of the user, and insert the advertisement into the appropriate location in the video stream. The system described by the Rosser patent is limited to providing ad-insertion for a single television receiver. Providing the aforementioned ad-insertion system on multiple receivers would require each receiver with the necessary hardware and software to accomplish playback. In other words, each receiver must have embedded or attached, a high-capacity storage device for storing the information representing the advertisement library, profile engine, and external network interface for receiving programming and advertisement information. The afore-mentioned items are normally included in a set-top box. The inclusion of a deluxe set-top box for each receiver greatly increases the cost and complexity of the system. Moreover, the previously known redundant systems do not allow playback of the same program with different ad-insertions based on the time of playback of a “live-paused” or previously recorded video. A further limitation of previously known systems is the lack of ability to target different advertisements to different receivers based on the location of the receiver within the home. Another limitation of prior art systems is the lack of a means to determine whether a television receiver is currently in use.

It is therefore desirable to significantly improve the prior art by providing a system with a feature for detecting locations for ad-insertion within a video stream, that system having the additional feature of being able to seamlessly pause and playback the video stream with the ad-insertion being accomplished at playback and where the desired advertisement can be selected based on one or more of a demographic profile based on the users watching habits, the location of the receiver within the home, and the time of playback, where viewing may occur from any of the receivers coupled to the system, and without the increased cost of related prior art approaches.

### SUMMARY OF THE INVENTION

In view of the aforementioned problems and deficiencies of previously known systems, embodiments of the present invention provide a distributed audio-visual reproduction system that at least includes a network adapted to facilitate the transmission and reception of information between components coupled thereto, a plurality of program reproduction devices coupled to the network, the reproduction devices being adapted to reproduce programs in a user-perceivable manner, and a media server coupled to the network, the media server being adapted to receive and store programs, reproducible by the reproduction devices, and the media server being adapted to upon the demand of a user via a reproduction device, transmit in a reproducible format, programs to the reproduction devices. The media server is further adapted to receive and store advertisements, reproducible by the reproduction devices, and the media server being adapted to select advertisements for insertion and insert advertisements into the program information stream.

An embodiment of the present invention also provides a distributed audio-visual reproduction method that at least includes the steps of, via a network, facilitating the transmission and reception of information between components coupled to the network, via a plurality of program reproduction devices coupled to the network, reproducing programs in a user-perceivable manner, via a media server coupled to the network, receiving and storing programs reproducible by the reproduction devices, via the media server, and upon the demand of a user via a reproduction device, transmitting in a reproducible format, programs to the reproduction devices, via one reproduction device and the media server, selecting advertisements based on a demographic model of the users viewing habits or viewing location and upon the transmission of the program to the reproduction device inserting said advertisements into the program information stream.

One embodiment of the present invention may be used in a home area network comprising a plurality of rendering devices and an advertisement manager to select a targeted advertisement for insertion in a content stream that is being rendered on one of the rendering devices. An active rendering device is identified in the home area network. Then, a targeted advertisement is selected for insertion in the content stream that is being rendered on the active rendering device, based on or responsive to a profile associated with the active rendering device. An advertisement manager in the home area network may perform the selection step. Then, the selected targeted advertisement is inserted in the content stream.

Another embodiment of the present invention may be used in a home area network comprising a plurality of rendering devices and a profile application to create or update a profile associated with one of the rendering devices. An active rendering device is identified in the home area network. Then, content-related information associated with a program rendered on the active rendering device is determined. Then a profile is created or updated based on or responsive to the identification and determination steps.

### BRIEF DESCRIPTION OF THE DRAWINGS

Features and advantages of embodiments of the present invention will become apparent to those skilled in the art from the description below, with reference to the following drawing figures, in which:

FIG. 1 is a schematic block diagram of a Home Area Network with which embodiments of the invention may be used;

FIG. 2 is a schematic block diagram of an alternative embodiment of a Home Area Network with which embodiments of the invention may be used;

FIG. 3 is a schematic block diagram illustrating various functional components of a system with which embodiments of the invention may be used;

FIG. 4 is a schematic block diagram illustrating various functional components of an alternative system with which embodiments of the invention may be used.

FIG. 5 is a schematic block diagram illustrating an example of a system in which an ad-insertion application may be used for ad-insertion.

FIG. 6 is a schematic block diagram illustrating an alternative example of a system in which an ad-insertion application may be used for ad-insertion.

FIG. 7 illustrates an example of a graphical interface menu that may be used in conjunction with an ad-insertion or profile application in various embodiments of the invention.

FIG. 8 illustrates one example of a set-top box or media server that may be used with various embodiments of the invention.

FIG. 9 illustrates a second example of a set-top box or media server that may be used with various embodiments of the invention.

FIG. 10 illustrates a third example of a set-top box or media server that may be used with various embodiments of the invention.

### DETAILED DESCRIPTION OF VARIOUS EMBODIMENTS OF THE INVENTION

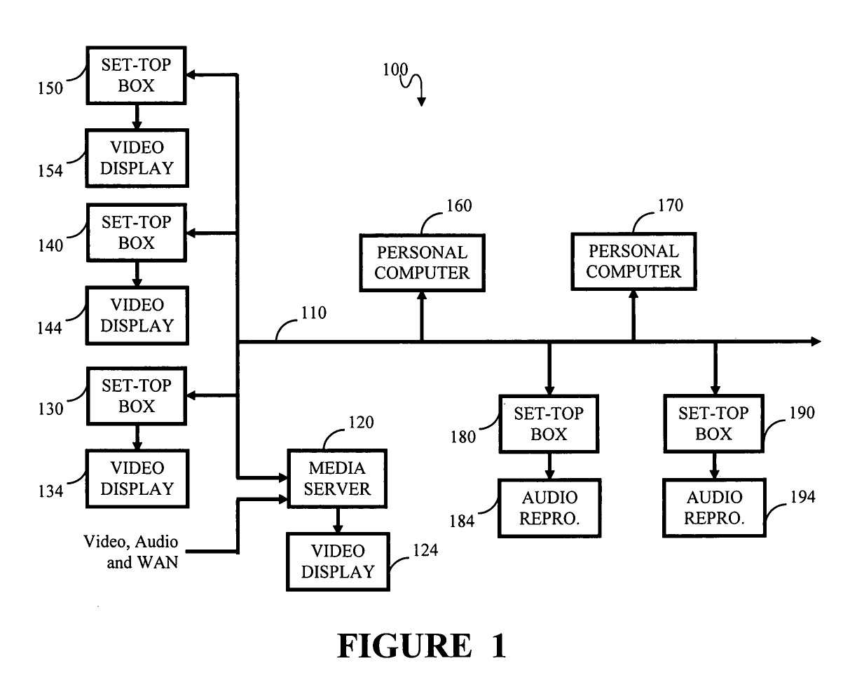

An embodiment of the present home area-networked digital video recording and playback system 100, capable of advertisement insertion and program playback from multiple receivers, is explained below with reference to FIG. 1. In its elementary form, the system 100 combines a media server 120 for receiving and storing multiple electronic audio visual programs (e.g., digital or analog television broadcasts, video recordings such as those provided by video-on-demand services, digital or analog audio-visual advertisement segements, or even audio programs), and several reproduction devices such as digital or analog television sets (134, 144 and 154) via a home area network (HAN). The media server acts as a centralized Digital Video Recorder and Playback device for all of the receivers connected to the HAN. The HAN itself is usually located on the customer premises side of a demarcation point separating the customer premises from service providers providing services to the customer premises, as well as a distribution network carrying communications from the service providers to the HAN (as well as other customers).

In one embodiment, the media server is adapted to receive programming information from at least one wide area network (WAN), store programming information, and communicate programming information to other devices within the home via a home area network 110 including, but not limited to audio visual reproduction devices such as digital or analog television sets (134, 144 and 154), audio reproduction devices such as stereo receivers (184 and 194) and personal computers (160 and 170). Network interface devices, such as digital set-top boxes (130, 140, 150, 180 and 190) are adapted to provide a network connection, audio or audio visual decoding, decrypting, and rendering of digital program information for legacy receiver devices such as analog television sets (134, 144 and 154) and stereo receivers (184 and 194) where said receiver devices do not include network interfaces or are incompatible with the home network. Those skilled in the art will appreciate that the functionality of the set-top boxes (130, 140, 150) can be integrated into the display devices (134, 144 and 154). In one embodiment, the home area network 110 is compatible with a high speed wired or wireless networking standard (e.g., Ethernet, HomePNA, 802.11a, 802.11b, 802.11g, 802.11g over coax, IEEE1394, etc.) although non-standard networking technologies may also be employed such as is currently available from companies such as Magis, FireMedia, and Xtreme Spectrum. In an alternative embodiment, a plurality of networking technologies is employed with a network bridge as known in the art. In this embodiment, a wired networking technology (e.g., Ethernet) may be used to connect fixed location devices, while a wireless networking technology (e.g., 802.11g) may be used to connect mobile devices. In one embodiment, the Media Server 120 is also capable of being a receiving device for audio visual information and interfacing to a legacy device Television 124.

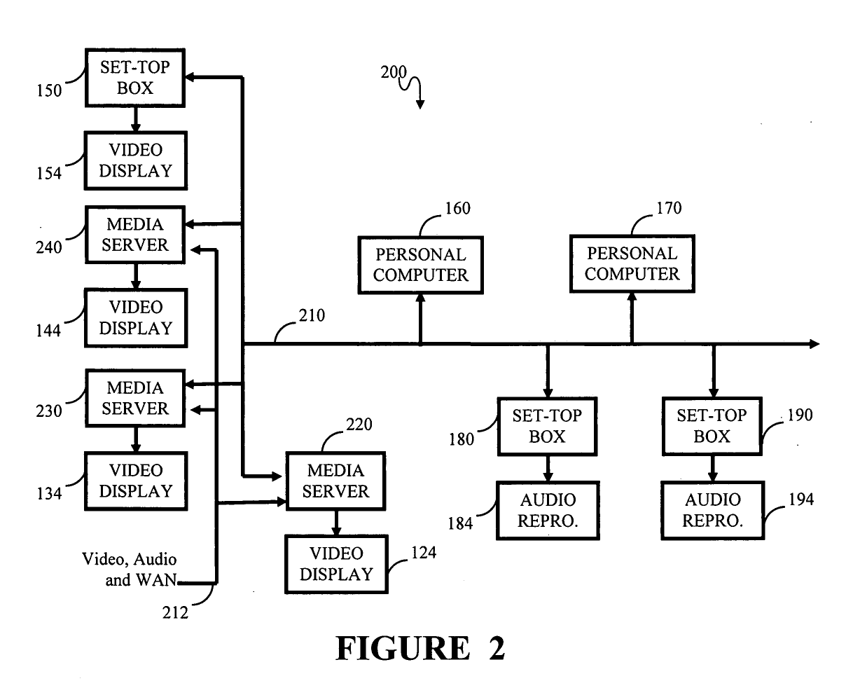

FIG. 2 shows a variation 200 of the network described above. Media Server capable devices 230 and 240 receive programming information from at least one WAN in parallel with the Media Server 220. In this embodiment, each media server capable device (220, 230 and 240) is enabled to communicate programming information to other devices via the HAN. One advantage to this arrangement is that it allows resources such as tuners and conditional access devices to be added to the network as additional receiving devices are added. In this embodiment storage resources may also be added to the secondary media server capable devices (230 and 240) or programming information received by these devices may be directly communicated to storage in the primary media server device 220. Those skilled in the art should appreciate that the physical layer distributing the WAN 212 and the HAN 210 may be the same, for example an 802.11g over coax HAN sharing the in-home coax with analog and digital cable WAN using frequency division multiplexing (FDM). In some embodiments using FDM, a filter (not shown) will be placed at the ingress to the home to prevent the HAN signal from leaking upstream.

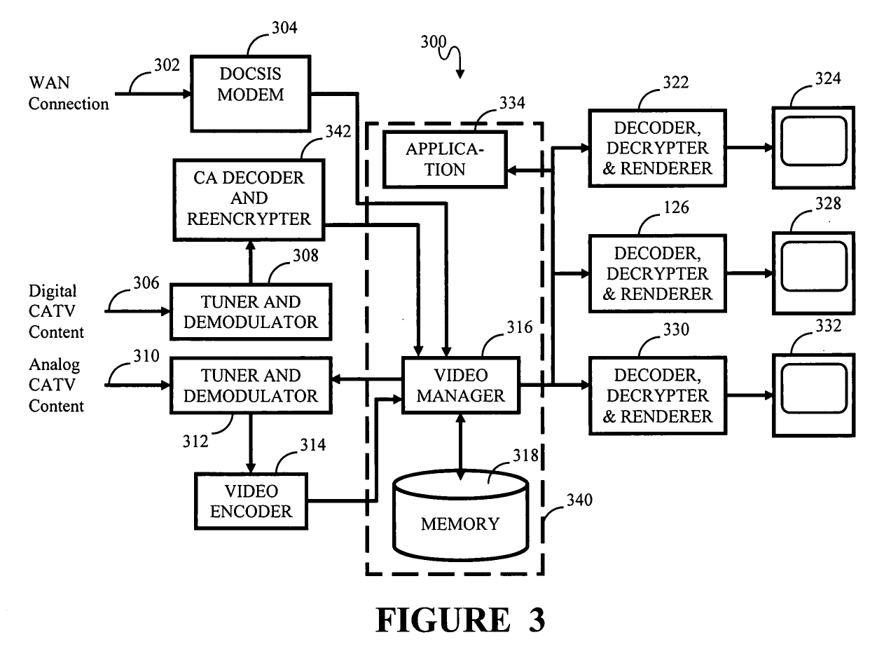

Referring now to FIG. 3, the functional components of an embodiment will be described. Media information is communicated to the system through, for example, a connection to a hybrid fiber-coax cable network via analog channels 310, digital channels 306 and/or a DOCSIS broadband connection 302. Other examples of WAN network connections include, but are not limited to xDSL, Satellite, fiber-to-the-home, fixed wireless, and over-the-air broadcast. Analog and Digital cable media content is received by a tuner and demodulator circuitry (308 and 312). In this embodiment, digital content is received in encrypted format and decrypted using the native conditional access mechanism of the cable provider and then re-encrypted for persistent storage using the conditional access decoder and re-encrypter module 342. Analog content is converted to digital format compatible with digital storage and optionally encrypted using the video encoder module 314. Media information can also be received through the DOCSIS modem 304 via, for example, a TCP/IP connection. Media content received from any source is indexed and written to Memory 318. In this embodiment, the Memory is a Hard Disk Drive but other methods are known in the art including solid-state memory, Random Access Memory, optical disk and magnetic tape. Application 334 provides interactive services (including a user interface) allowing the user to access media through various means including a video library, video on demand, electronic program guide and/or live-pause functionality. An example application is an advertisement manager responsible for managing the storage of program information tagged as commercial content as received from that WAN, detecting the appropriate slots in program information being transmitted to decoder devices for playback, selecting an appropriate advertisement based on, for example, program information content, playback time, playback location (e.g., bedroom, living room) and/or the demographic profile of the user. Another example of an application is a demographic profiler adapted to monitor, for example, the content viewed within the household, by a specific viewer (e.g., using login information), and/or by location within the home by tracking meta data associated with the program information tagging, for example actor, genre, title, etc., receiving demographic group profile information from the WAN, and comparing the monitored demographic profile information with the demographic group profile information to provide other applications with predictors into the expected demographic profile of the current viewer. The profile or profile application may additionally use other factors in constructing a profile, such as the amount of time a viewer spends viewing particular types of programs (e.g., as characterized by the meta data associated with the programs), or whether a user has input a program-control command that prevents or restricts the viewing of programs of a particular type (e.g., based on the characterizing meta data associated with that type of program) on rendering devices in the HAN. Correspondingly, the advertisement manager may serve advertisements of a particular type based on these factors in the profile; for example, if a user of the HAN has entered a command (stating that programs with adult-oriented content are not to be displayed on rendering devices of the HAN, then the advertisement manager may be configured to reject and not serve to HAN rendering devices advertisements containing adult-oriented content. Similarly, if the profile application consistently determines that fishing programs are being viewed (e.g., based on the corresponding meta data) for long amounts of time, the profile is updated accordingly, and the advertisement manager may serve advertisements directed to fishing to HAN rendering devices, based on the updated profile.

In another aspect of this embodiment, a profile associated with a HAN devices may be updated differently based on user input through a remote control device. For example, entry of a password or PIN into the HAN device through a remote control device for access to programs of a given type may cause the profile to be updated so that advertisements of the same or a corresponding type are served to that HAN device. In a specific example, entry of a password or PIN into a HAN viewing device in the master bedroom of a house for access to adult-oriented programming may cause the profile associated with that device to be updated accordingly, so that advertisements of the same or similar type (e.g., based on meta data associated with each of the advertisment and such programming) are served to that device but not to other HAN devices, such as one located in a child's bedroom. In this example, the advertisement served to the device in the master bedroom may, e.g., be an advertisement for Viagra®, whereas the advertisement served to the device in the child's bedroom may be for a cereal (in one subembodiment, independent of whether at that particular time interval both devices are displaying the same or a different program.)

Application 334 may additionally provide an applications programming interface to video manager 316. In an embodiment, application 334 renders a graphical user interface using a virtual frame buffer 336 (not shown) local to the processor running one or more applications, and rendering commands and/or rendered graphics are transferred to a graphics blender (not shown) where they are blended with a video stream decoded by a video decoder, e.g., at least one of decoders 322, 126 and 330, which receives the video stream from the video manager 316. The blended graphics are provided to a television receiver or video monitor 324 and/or video monitors 328 and 332. In this embodiment, user input is received via an IR receiver and commands are communicated back to application 334 via a digital interface (not shown). In this embodiment, the interfaces between the functional units described here have been designed to operate either within the same processing unit, or distributed across processing units located at various points on a network. For example, digital tuner and demodulator 308 and the conditional access (“CA”) decoder and re-encrypter 342 communicate with the video manager using an interprocess communication protocol (e.g., Sockets). This allows tuner/demodulator 308 and CA decoder/re-encrypter 342 to be located within the same unit (e.g., set-top box) as the video manager 316 and memory 318. Alternatively, these modules may reside in different units (e.g., set-top boxes) and communicate over a network. Other links may also span the network. It should be appreciated by those skilled in the art that multiple instantiations of key components can be made to support, for example, multiple tuners, multiple decoders, and multiple video displays. A centralized primary resource manager, co-located, for example, with video manager 316, may detect resources as they are added to the network, and facilitate inter-module communications, as will be described in more detail below. One example of a primary resource manager is discussed in U.S. provisional patent application No. 60/372,490, filed Apr. 10, 2002 and entitled “Centralized resource manager for use with a networked personal video recorder,” which is herein incorporated by reference in its entirety.

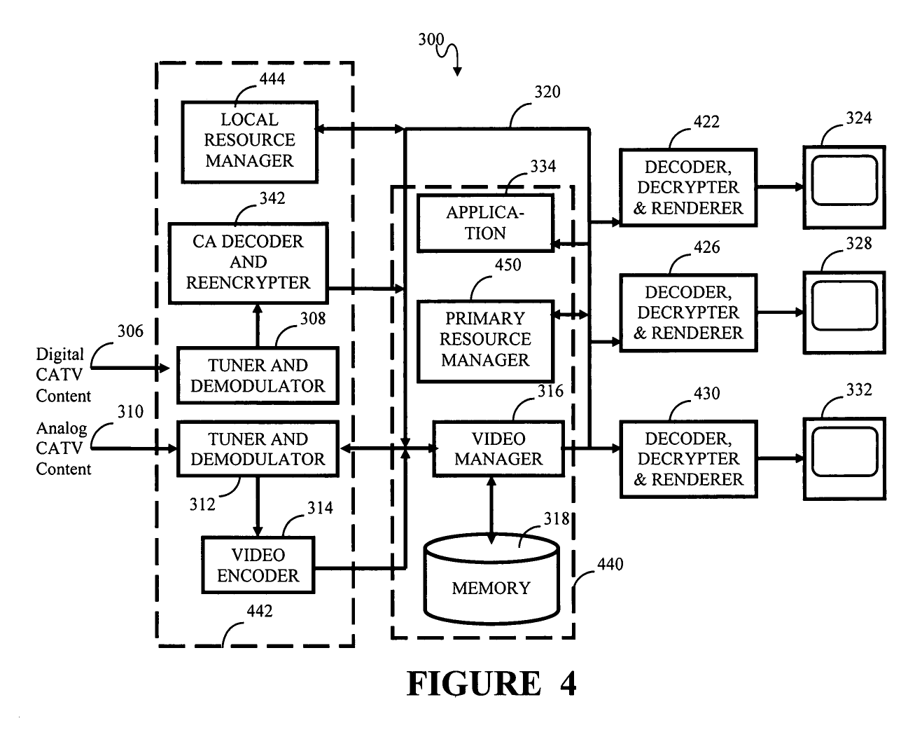

An alternative representation of an embodiment of the present invention is illustrated in FIG. 4. HAN 320 connects various components including a media server 440, media playback devices, e.g., decoders 422, 426 and 430, and a tuner module 442. In an example embodiment, tuner module 442 and a decoder/decrypter module, e.g., decoder 422, are integrated into a single set-top box. Other devices on the HAN, including the media server, may also include tuner modules. Each device on the network with controllable resources is adapted to be coupled with a resource manager, e.g., local resource manager 444, capable of communicating over the network a list of resources contained in the device, and facilitating the negotiation and control of those resources by primary resource manager 450. In this embodiment, all devices on the network provide local resource managers. In an alternative embodiment, devices lacking local resource managers can be controlled by resource managers elsewhere on the network by another resource manager providing a proxy service. The primary resource manager is responsible for detecting all resources on the network via communication with local resource managers. For example, tuner module 442 may be added to the network. The local resource manager 444 requests an IP address using the Dynamic Host Configuration Protocol (“DHCP”). On detection of a new device on the network, a DHCP service in the HAN instructs primary resource manager 450 of new devices on the network. Alternatively, or in addition to the above, primary resource manager 450 periodically polls for the existence of new resources on the network. Primary resource manager 450 communicates with local resource manager 444 over HAN 320, and local resource manager 444 provides a list of resources available in tuner module 442. Primary resource manager 450 maintains a list of all available resources on the network. If devices are removed cleanly from the network, for example, by the device performing a shutdown operation, the local resource manager will communicate with primary resource manager 450 to indicate that the associated resources are being removed from the system. In the event of a device failure or resources otherwise becoming unavailable, applications or services attempting to use or relying on those resources will throw an exception and communicate to primary resource manager 450 that the device is no longer available. When an application 334 starts up, it will request the necessary resources from primary resource manager 450. For example, if application 334 is a video recording application, it may receive input from a user wishing to record a program through the use of an electronic program guide. Application 334 will provide primary resource manager 450 with a list of required resources for a media pipeline, in this example, a digital capable tuner, a conditional access decoder/reencrypter, and sufficient storage space to store the program information. Primary resource manager 450 will consult its list of available resources and assign resources using, for example, a least-cost algorithm. In this example, digital tuner/demodulator 308 is available with CA decoder/re-encrypter 342 in tuner module 442. In this example, the only available storage is in the media server 440; part of this storage capacity may be assigned, along with tuner/demodulator 308 and CA decoder/re-encrypter 342, by primary resource manager 450 to application 334. The tuner module 442 and media server 440 are connected through HAN 320. Primary resource manager 450 constructs a graph of the available pipeline, and adds the resource of the required network bandwidth on the HAN. Primary resource manager 450 further consults the list of available resources to determine if the required HAN bandwidth is available. If all resources are available for the time period required, primary resource manager 450 will communicate a successful reservation to the calling application, application 334.

In an embodiment, an ad-insertion application is adapted to communicate with a advertisement server on the WAN. The advertisement server provides program information in the form of media advertisements to be stored in memory. In this embodiment, the advertising program information is provided in the form of a digital television program, and the advertising server provides the application with scheduling information for recording advertisements as well as meta data describing the advertisements. In one alternative embodiment, an advertisement is available for download over an internet protocol connection through DOCSIS modem 304. In another alternative embodiment, advertising information is available as an analog program on an analog channel. Other methods of providing program information over a wide area network are known to those skilled in the art. In this embodiment, ad-insertion application 334 requests resources from primary resource manager 450 for recording advertisement program information, with this request for resources being at a lower priority from user originated requests for resources. In one alternative embodiment, extra resources are added to the system assigned specifically to the task of recording advertisement program information. In another alternative embodiment, ad-insertion application 334 can request resources at the same or higher priority as user originated requests.

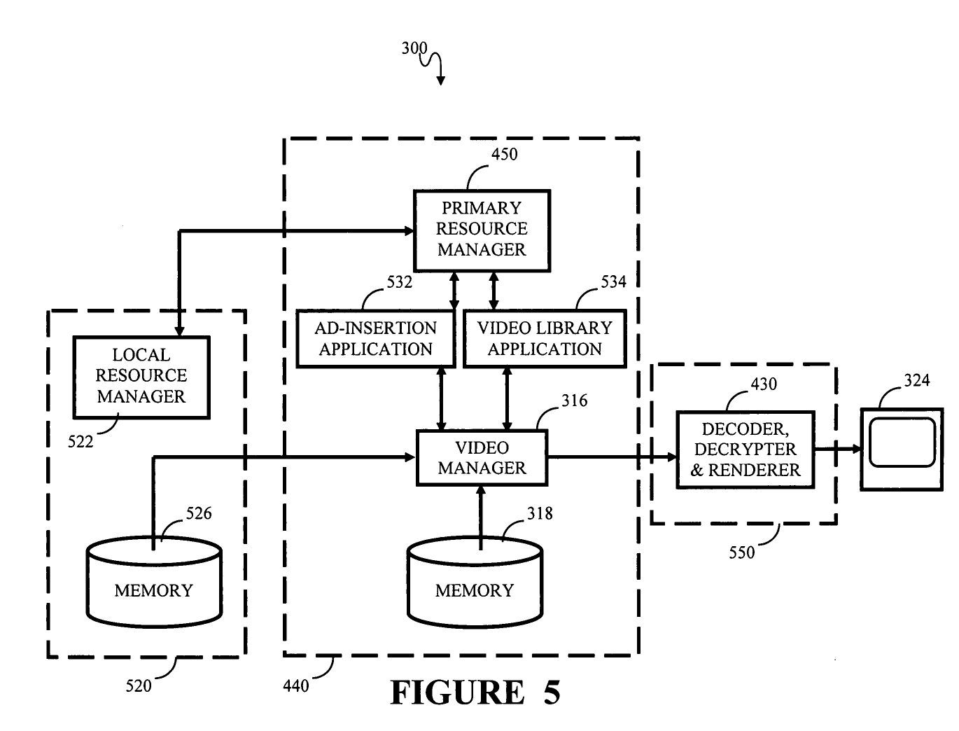

FIG. 5 illustrates one example of a pipeline generated to communicate a “live-pause” or pre-recorded program to a television receiver or video display 324 with ad-insertion. In this example, a user has requested playback of a program using an video library or electronic program guide application, e.g., application 534. This application communicates with video manager 316 and determines that the program information requested is stored on a hard drive storage device 318. In this example, a user initiates playback by pressing play on an IR remote control communicated back to application 534 from set-top box 550 over HAN 320. When the play command is received by application 534, the application requests resources from primary resource manager 450 to deliver the program stream from memory 318 to decoder/decrypter/renderer 430 contained in set-top box 550, where the user is requesting the playback. In an alternative embodiment, the necessary resources to complete a playback pipeline are requested when the network is configured at power-up or when resources are added to the network rather than when a playback session is requested. If the resources are available, the resource manager facilitates connection of the desired pipeline, and application 534 communicates to video manager 316 its request to start the playback of the relevant program information. Ad-insertion application 532 communicates with video manager 316 to indicate the appropriate advertisement program information to insert into the requested content program information. In this example, advertisement program information is distributed across two storage devices (memory 526 and memory 318). Ad-insertion application 532 requests the necessary resources required to communicate advertisement program information from the storage device 526 to the video manager 316. Several protocols are known in the art for allowing distributed storage including WEBDAV, SAMBA, NFS and iSCSI. If there are not sufficient resources to communicate advertisement program information from storage device 526 to video manager 316 over the network, ad-insertion application 532 will limit the insertion of advertisements to advertisment program content located on storage device 318. Video manager 316 is responsible for inserting advertisements as directed by the advertisement manager (which may be part of ad-insertion application 532) into the content program information stream before transmitting the modified program information stream to the decoder/decrypter/renderer 430. De-coder/decrypter/renderer 430 receives the modified program information stream and decrypts the stream if needed, decodes the audio-visual information, renders the video stream and converts the video stream to the appropriate signaling to drive the display device (e.g., component video and/or PCM audio). In streaming content and advertisements to decoder/decrypter/renderer 430, a streaming manager application that is part of, e.g., video manager 316, may implement any known streaming protocol. For example, the streaming manager application may implement a standard applications-layer streaming protocol such as Real Time Streaming Protocol (“RTSP”) over a standard transport-layer protocol such as Real Time Protocol (“RTP”) for this purpose. RTSP and RTP are disclosed and discussed in RFC 2326 (Network Working Group, April 1998) and RFC 1889 (Network Working Group, January 1996), respectively, each of which is herein incorporated by reference. However, other known streaming protocols may be used for this purpose, as will be known to those of skill in the art.

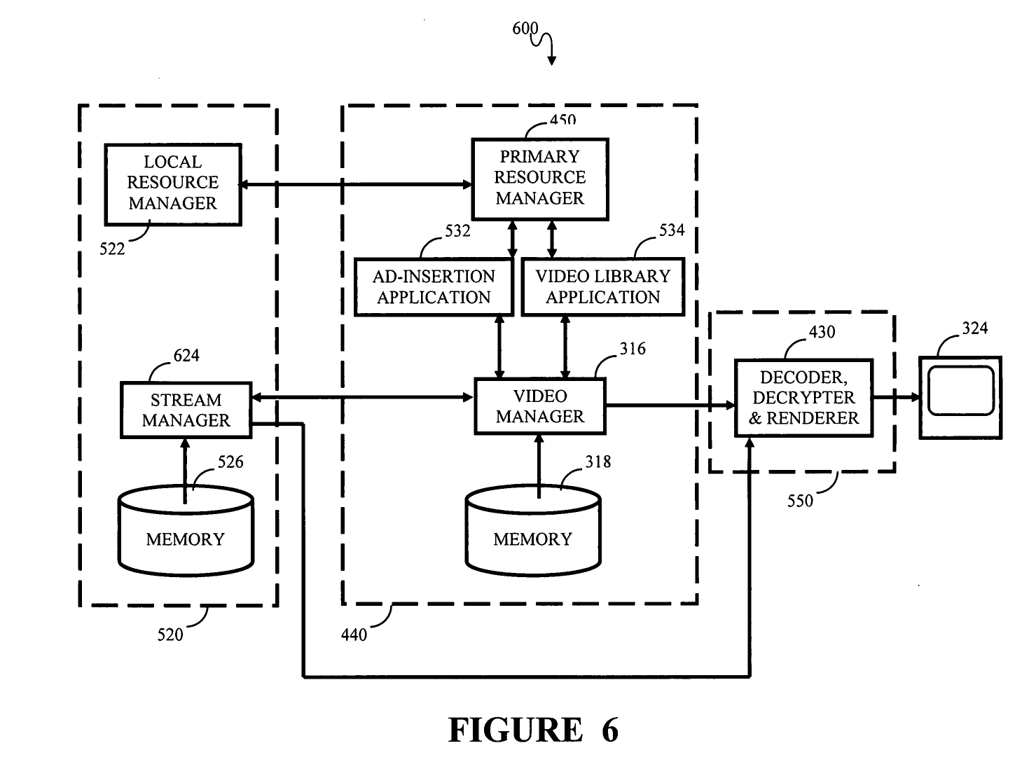

FIG. 6 illustrates a further improvement on the embodiment described in FIG. 5. The new embodiment 600 adds a stream manager 624 to the networked storage device 520. Stream manager 624 is adapted to transmit program information directly to the decoder/decrypter/render 430 in the networked set top box 550. Considering again the example of playback of content program information from storage device 318 with advertisment program information from storage device 526, the addition of stream manager 624 under control of video manager 316 facilitates communication of program information to set top box 550, without consuming the additional bandwidth due to first transmitting the advertisement program information to video manager 316. In an alternative embodiment, video manager 316 communicates with set-top box 550 which utilizes a pull mechanism to pull content program information from video manager 316 and advertisement program information from stream manager 624, and merges the content prior to communicating the modified program information stream to decoder/decrypter/renderer 430.

In an embodiment, decoder/decrypter/renderer 430 is a system-on-chip (SOC) integrated-circuit device with a computer program adapted to monitor communication channels (e.g., TCP/IP sockets) through a network connection to the HAN. Several communication channels may be open simultaneously, including a control channel, a primary audio-visual channel and one or more secondary audio-visual channels. Video library application 534 uses the control channel to send commands to instruct decoder/decrypter/renderer 430 to start monitoring a second audio-visual channel for audio-visual program information. Video library application 534 also instructs video manager 316 to start streaming the content program information over the audio-visual channel. In this embodiment, ad-insertion application 532 provides video manager 316 with an or dered list providing which advertisement program information streams to make available for the current session and video manager 316 creates an additional audio-video communication channel to provide the advertisement program information. If advertisement program information exists on more than one storage device, a separate communications channel is created for each pipeline. The allocated bandwidth is shared among the program information channels leading to a common decoder/decrypter/renderer, e.g., decoer/decrypter/renderer 430. Decoder/decrypter/renderer 430 plays the content program information stream until a location in the stream that was tagged for advertisement insertion is detected. Decoder/decrypter/renderer 430 will then start playing the program information from one of the advertisement program information streams as instructed by the commands on the control channel. The communications channels are adapted to perform a “pull” data protocol where the transmitting device only sends data when it is requested by the receiving device. This prevents data being sent over the network from more than one associated program information channel at a time, keeping the bandwidth usage within the range allocated to that specific playback session.

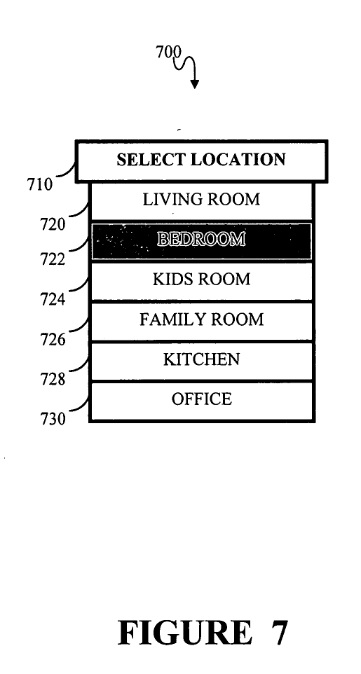

Referring now to FIGS. 1 and 7, a further improvement provided in certain embodiments of the invention is the ability for a user to select the location of the television or display device within the home, with this information being communicated to at least one of the ad-insertion application and/or a profile application (either or both of which may be part of application 334 of FIG. 4). In this embodiment, the user selects the location using a graphical user interface menu 700 with menu items 720, 722, 724, 726, 728, and 730, which represent different locations. Those skilled in the art should appreciate that there are other methods known for providing a graphical user interface allowing a user to select and/or enter information such as location. The ad-insertion application is preferably adapted to consider the location of the playback session as a means of selecting or weighing in the selection of the advertisement program information to be inserted into the content program information stream. In this embodiment, a demographic profile application is adapted to separately track and predict the demographic profile of the user separately by the location. By example, a separate demographic profile is generated for the session displayed at each video reproduction device 124, 134, 144 and 154, where each may be located in a different room of the house. The location information received through configuration menu 700 provides additional demographic information for generating the profile.

As discussed above, the profile that is used in various embodiments of the invention for purposes of selecting advertisements for display on a particular device in the HAN depends on the location of that device. Thus, in these embodiments, a separate profile is tracked for each different rendering device in the HAN; in other words, an individual profile may be tracked for and associated with each rendering device in the HAN. One consequence of this is that the profiles associated with different devices in the HAN may differ, even if the devices are used to simultaneously view or listen to the identical program. For example, even if the profiles for two devices in the HAN are initially identical, when the profile for each device is updated based on a rendering of a program on that device (here “updated” broadly denotes either creation of the profile from scratch or an update to an already-existing profile), the updated profile of the first device may differ from the updated profile of the second.

Similarly, targeted advertisements served to different devices in the HAN may differ, even if the respective viewers are viewing or listening to the same program at the same time, because the targeted advertisements in the present embodiments of the invention are based on the respective profiles associated with the devices, which in turn may differ as discussed immediately above. More generally, the advertisement manager may serve a targeted advertisement to a first rendering device in the HAN at approximately the same time as either a differing targeted advertisement served to a second rendering device in the HAN, or a program that is not an advertisement that is rendered on the second rendering device. For example, the set of targeted advertisements served to the first rendering device may differ from the set of targeted advertisements served to the second rendering device during the time the programs into which these targeted advertisements are inserted are being rendered on the devices.

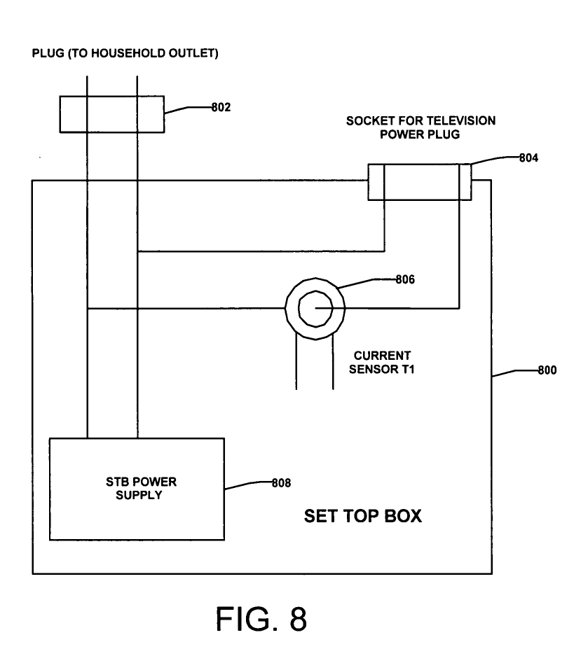

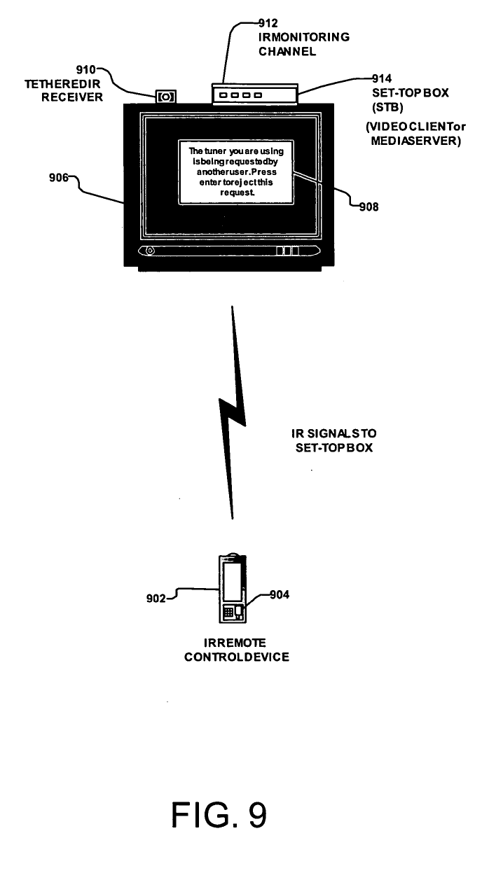

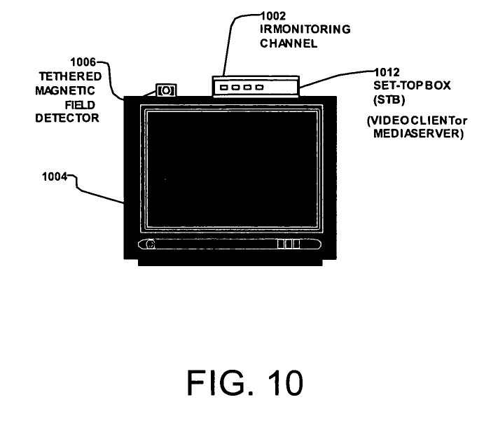

Referring now to FIGS. 8, 9 and 10, an additional aspect of an embodiment of the present invention will be described. FIGS. 8, 9 and 10 illustrate a set-top box or media server adapted to deliver a live, live-pause or pre-recorded media playback session to a video display or television receiver. FIG. 8 illustrates an example set-top box 800 that has been adapted to provide power to the video display or receiver through a pass-through power plug 804. A television or video display plugged into the power plug 804 receives power through the set-top box that is powered via a plug to a household outlet 802. Set-top box 800 has been adapted to include a current sensor 806. Various methods of constructing a current sensor are known in the art. The current sensor has been adapted to detect the change in the current flow of the wires providing power to the television receiver or video monitor plugged in to the power plug 804. When the television or video monitor is turned off, the current flowing through plug 804 will be minimal as the set is in stand-by mode. When the television or video monitor is powered on, the current flowing to the plug will increase to supply the power needed for operation of the television or video monitor. Set-top box 800 is adapted to detect the change in current level through the use of a comparator circuit, digital sampling circuit or other electronic detection circuits known in the art. The detection circuit is coupled to set-top box 800 in such a way that the status of the television can be monitored by computer programs running on set-top box 800, or communicated over a home area network to computer programs running on another device such as a media server. Turning now to FIG. 9, a set-top box 914 is shown with an IR receiver 910. IR receiver 910 can be tethered (as shown) or built integral to the set-top box. IR receiver 910 is capable of detecting IR commands issued by remote control device 902. In one embodiment, IR receiver 910 and set-top box 914 are configured to detect at least the power-off and power-on, or power-toggle IR codes transmitted by remote control device 902. The IR commands can be processed by at least one of a processor running on the set-top box, or a processor located elsewhere on the home area network. By monitoring the key presses on remote control device 902, a program running on a processor connected to the home area network can make a prediction as to whether anyone is currently watching the television or video monitor 906. For example, if an ‘off-command’ is pressed, there is a high degree of likelihood that the television has been turned off. In the cases where a single on-off toggle command is used, an on-off command followed by additional IR commands is likely to predict that the television is in an on state, while an on-off command with no following IR commands is likely to predict that the television is in the off state, especially if IR commands where detected prior to the on-off toggle. In this way a program running on a processor located on the home area network is capable of making a prediction about whether someone is watching the television or video monitor. Turning now to FIG. 10, set-top box 1012 is adapted to detect the electromagnetic fields generated by the television or video monitor 1004. The set-top box includes a tethered electromagnetic field detector 1006, although electromagnetic field detector 1006 could also be built into set top box 1012. Electromagnetic field detectors are known to those skilled in the art, for example one well-known type of detector is the Hall-Effect sensor. By monitoring the output of electromagnetic field detector 1006, a processor located on set-top box 1012 can determine whether the television or video display 1004 is in a powered-on or powered-off state. This state can also be communicated to processors located elsewhere on the home area network. By monitoring the state of television or video display 1004, the system can make a prediction about the likelihood of someone watching the television or video display 1004. Other methods of determining the state of the television exist, including providing a switched outlet on a set-top box to remove power from the television through an interface to the set top box. One embodiment of the present invention uses at least one method for predicting the likelihood of a given video session being watched. This information is used to improve the quality of the information used to determine demographic profiling of the system. For example, a household may contain two adults but no children. One viewer tunes to a PBS documentary on the civil war and watches the program in its entirety. The demographic profile application will use the meta data describing this show to increase the weighting of likelihood that this viewer enjoys history programs. At the conclusion of the documentary, the viewer turns off the television, but does not explicitly provide input to the DVR system that they are no longer watching the content presented. Following the documentary, Sesame Street is aired. Embodiments of the present invention use one or more of the means above for determining that while the broadcast of Sesame Street is airing by default, the fact that the television is turned off means that nobody is watching this show. Without this feature, the profile application would likely increase the weight of likelihood that viewers within the home enjoy children's shows. With this feature, this weighting is unchanged, and the couple will not be barraged with advertisements for toys and children's cereals.

The structures shown and discussed in apparatus embodiments of the invention are exemplary only and the functions performed by these structures may be performed by any number of structures, as is known to those of skill in the art. All of such possible variations are within the scope and spirit of embodiments of the invention and the appended claims.

Propagating signals embodied in a medium, such as a carrier wave or other carrier medium, that are products of embodiments of methods of the invention, or products of the use of embodiments of systems or devices of the present invention, are within the scope and spirit of the present invention and the appended claims. Similarly, any medium containing instructions that are readable by a processor and that, when executed by the processor, perform the steps of method embodiments of the present invention, are also within the scope and spirit of the present invention and the appended claims.

Other variations and modifications of the present invention are possible, given the above written description and the appended drawings. Persons skilled in the art will recognize from these that the invention is not limited to the embodiments described, and may be practiced with modifications and alterations limited only by the spirit and scope of the appended claims which are intended to cover such modifications and alterations, so as to afford broad protection to the invention and its equivalents.

What is claimed is:

1. In a home area network comprising a plurality of rendering devices and an advertisement manager, a method for selecting a targeted advertisement for insertion in a content stream, the method comprising:
identifying an active rendering device from among the plurality of rendering devices;
selecting, responsive to a profile associated with the active rendering device, a targeted advertisement for insertion in a content stream rendered on the active rendering device; and
inserting the selected targeted advertisement in the content stream,
wherein the selecting step is carried out by the advertisement manager.

2. The method of claim 1 wherein the profile associated with the active rendering device is updated by a profile application in the home area network.

3. The method of claim 1 wherein the home area network is located wholly on the customer premises side of a demarcation point marking a separation from a carrier network.

4. The method of claim 1 wherein the home area network is located wholly within or approximately adjacent to a customer premises.

5. The method of claim 1 further comprising:
determining the time of rendering of the content stream on the active rendering device; and
selecting the targeted advertisement additionally responsive to the determined time.

6. The method of claim 1 further comprising:
identifying a user viewing the content stream on the active rendering device; and
selecting the targeted advertisement additionally responsive to the identified user.

7. The method of claim 1 further comprising:
receiving a user-entered program-control command; and
selecting the targeted advertisement additionally responsive to the received user-entered program-control command.

8. In a home area network comprising a plurality of rendering devices and an advertisement manager, a method for selecting targeted advertisements for insertion in content streams, the method comprising:
identifying a first active rendering device from among the plurality of rendering devices;
identifying a second active rendering device from among the plurality of rendering devices;
selecting, responsive to a first profile associated with the first active rendering device, a first targeted advertisement for insertion in a first content stream rendered on the first active rendering device;
inserting the first targeted advertisement in the first content stream approximately concurrently with either:
a rendering, responsive to a second profile associated with the second active device, of a second targeted advertisement in a second content stream rendered on a second active rendering device, or
a rendering of the second content stream on the second active rendering device,
wherein the selecting step is carried out by the advertisement manager, and each of the second content stream and the second targeted advertisement differs from the first targeted advertisement.

9. The method of claim 8 wherein the second targeted advertisement is selected by the advertisement manager.

10. The method of claim 8 wherein the home area network is located wholly on the customer premises side of a demarcation point marking a separation from a carrier network.

11. The method of claim 8 wherein the home area network is located wholly within or approximately adjacent to a customer premises.

12. In a home area network comprising a plurality of rendering devices and an advertisement manager, an apparatus for selecting a targeted advertisement for insertion in a content stream, the apparatus comprising:
means for identifying an active rendering device from among the plurality of rendering devices;
means for selecting, responsive to a profile associated with the active rendering device, a targeted advertisement for insertion in a content stream rendered on the active rendering device; and
means for inserting the selected targeted advertisement in the content stream.

13. The apparatus of claim 12 wherein the profile associated with the active rendering device is updated by a profile application in the home area network.

14. The apparatus of claim 12 wherein the home area network is located wholly on the customer premises side of a demarcation point marking a separation from a carrier network.

15. The apparatus of claim 12 wherein the home area network is located wholly within or approximately adjacent to a customer premises.

16. The apparatus of claim 12 further comprising:
means for determining the time of rendering of the content stream on the active rendering device,
wherein the means for selecting is additionally responsive to the determined time.

17. The apparatus of claim 12 further comprising:
means for identifying a user viewing the content stream on the active rendering device,
wherein the means for selecting is additional responsive to the identified user.

18. The apparatus of claim 12 further comprising:
means for receiving a user-entered program-control command,
wherein the means for selecting is additionally responsive to the received user-entered program-control command.

19. In a home area network comprising a plurality of rendering devices and an advertisement manager, an apparatus for selecting targeted advertisements for insertion in content streams, the apparatus comprising:
means for identifying a first active rendering device from among the plurality of rendering devices;
means for identifying a second active rendering device from among the plurality of rendering devices;
means for selecting, responsive to a first profile associated with the first active rendering device, a first targeted advertisement for insertion in a first content stream rendered on the first active rendering device;
means for inserting the first targeted advertisement in the first content stream approximately concurrently with either:
a rendering, responsive to a second profile associated with the second active device, of a second targeted advertisement in a second content stream rendered on a second active rendering device, or
a rendering of the second content stream on the second active rendering device,
wherein each of the second content stream and the second targeted advertisement differs from the first targeted advertisement.

20. The apparatus of claim 19 wherein the second targeted advertisement is selected by the means for selecting.

21. The apparatus of claim 19 wherein the home area network is located wholly on the customer premises side of a demarcation point marking a separation from a carrier network.

22. The apparatus of claim 19 wherein the home area network is located wholly within or approximately adjacent to a customer premises.

23. A computer-readable storage medium storing instructions that, when executed by a computer, cause the computer to perform, in a home area network comprising a plurality of rendering devices and an advertisement manager, a method for selecting a targeted advertisement for insertion in a content stream, the method comprising:
identifying an active rendering device from among the plurality of rendering devices;
selecting, responsive to a profile associated with the active rendering device, a targeted advertisement for insertion in a content stream rendered on the active rendering device; and
inserting the selected targeted advertisement in the content stream,
wherein the selecting step is carried out by the advertisement manager.

24. The computer-readable storage medium of claim 23 wherein the profile associated with the active rendering device is updated by a profile application in the home area network.

25. The computer-readable storage medium of claim 23 wherein the home area network is located wholly on the customer premises side of a demarcation point marking a separation from a carrier network.

26. The computer-readable storage medium of claim 23 wherein the home area network is located wholly within or approximately adjacent to a customer premises.

27. The computer-readable storage medium of claim 23, wherein the method further comprises:
determining the time of rendering of the content stream on the active rendering device; and
selecting the targeted advertisement additionally responsive to the determined time.

28. The computer-readable storage medium of claim 23, wherein the method further comprises:
identifying a user viewing the content stream on the active rendering device; and
selecting the targeted advertisement additionally responsive to the identified user.

29. The computer-readable storage medium of claim 23, wherein the method further comprises:
receiving a user-entered program-control command; and
selecting the targeted advertisement additionally responsive to the received user-entered program-control command.

30. A computer-readable storage medium storing instructions that, when executed by a computer, cause the computer to perform, in a home area network comprising a plurality of rendering devices and an advertisement manager, a method for selecting a targeted advertisement for insertion in a content stream, the method comprising:
identifying a first active rendering device from among the plurality of rendering devices;
identifying a second active rendering device from among the plurality of rendering devices;
selecting, responsive to a first profile associated with the first active rendering device, a first targeted advertisement for insertion in a first content stream rendered on the first active rendering device;
inserting the first targeted advertisement in the first content stream approximately concurrently with either:
a rendering, responsive to a second profile associated with the second active device, of a second targeted advertisement in a second content stream rendered on a second active rendering device, or
a rendering of the second content stream on the second active rendering device,
wherein the selecting step is carried out by the advertisement manager, and each of the second content stream and the second targeted advertisement differs from the first targeted advertisement.

31. The computer-readable storage medium of claim 30 wherein the second targeted advertisement is selected by the advertisement manager.

32. The computer-readable storage medium of claim 30 wherein the home area network is located wholly on the customer premises side of a demarcation point marking a separation from a carrier network.

33. The computer-readable storage medium of claim 30 wherein the home area network is located wholly within or approximately adjacent to a customer premises.

34. In a home area network comprising a plurality of rendering devices and a media server, an apparatus for selecting a targeted advertisement for insertion in a content stream, the apparatus comprising an advertisement manager part of or executing on the media server, the advertisement manager configured to:
identifying an active rendering device from among the plurality of rendering devices;
selecting, responsive to a profile associated with the active rendering device, a targeted advertisement for insertion in a content stream rendered on the active rendering device; and
inserting the selected targeted advertisement in the content stream.

35. A signal embedded in a medium representing data corresponding to a selected targeted advertisement, the data produced responsive to encoded instructions that when executed by a computer cause the computer to perform, in a home area network comprising a plurality of rendering devices and an advertisement manager, a method for selecting a targeted advertisement for insertion in a content stream, the method comprising:
identifying an active rendering device from among the plurality of rendering devices;
selecting, responsive to a profile associated with the active rendering device, a targeted advertisement for insertion in a content stream rendered on the active rendering device; and
inserting the selected targeted advertisement in the content stream,
wherein the selecting step is carried out by the advertisement manager.
